(19) United States
(12) Patent Application Publication
(10) Pub. No.: US 2006/0290290 A1
(43) Pub. Date: Dec. 28, 2006

(54) Plasma display device

(76) Inventor: Seunguk Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/443,466

(22) Filed: May 30, 2006

(30) Foreign Application Priority Data
May 31, 2005 (KR) 10-2005-0046197

(51) Int. Cl. G09G 3/10; H01J 17/49

(52) U.S. Cl. 315/169.3; 313/582; 313/583

(57) ABSTRACT

Disclosed is a plasma display device. The plasma display device including a front substrate on which phosphors are formed is provided. The phosphors can be formed on the recess which is formed on the front substrate. A plurality of recesses for phosphors can have various numbers and shapes. A plasma display device with two electrodes or three electrodes is provided. The electrodes may be buried in the barrier ribs. In addition, a method for manufacturing the above described plasma display device and a method for displaying an image using the above described plasma display device are disclosed.

### CROSS-REFERENCE TO RELATED APPLICATIONS

The present application claims priority to Korean patent application No. 10-2005-0046197 filed in the Korean Intellectual Property Office on May 31, 2005, and all the benefits accruing therefrom under 35 U.S.C.§119, the contents of which are herein incorporated by reference in their entirety.

### BACKGROUND

1. Field

The present invention relates to a plasma display panel (PDP) device, and more particularly to a plasma display device with a structure that is capable of realizing high efficiency and enhanced display quality.

2. Description of the Related Technology

A PDP is a display device that displays an image using a visible light generated when vacuum ultraviolet rays excite phosphors. The vacuum ultraviolet rays are radiated from plasma which is formed by gas discharge. Since a large display with high resolution can be realized by using such a PDP, it is spotlighted as a thin display device.

A typical PDP includes three electrodes for planar discharging. The three-electrode PDP includes a front substrate on which two display electrodes are formed, and a rear substrate on which an address electrode is formed. The rear substrate is spaced apart from the front substrate by a predetermined distance. The space between the substrates is partitioned into a plurality of discharge cells by barrier ribs. Phosphors are formed on the side and rear surfaces of the discharge cells, not the front surface thereof. The discharge cells are individually sealed and discharging gas is filled in the discharge cells.

In operation, a specific discharge cell is selected by an address discharge and a sustain discharge. The address discharge refers to a short plasma discharge within the discharge cell created by one of the two display electrodes and the address electrode. The sustain discharge is performed by the two display electrodes passing by the selected discharge cell.

Typically, display electrodes are disposed on the side of the front substrate in the discharge cells. As a result, the display discharge occurs only near the front substrate. As such, the discharge space of the discharge cells may not be optimally utilized. On the other hand, as noted above, phosphors are formed on the rear and side surfaces apart from the front substrate. Thus, the phosphors may not maximally utilize the plasma discharge occurring toward the front substrate. Therefore, there is a need for improving efficiency of emitting light for the PDP devices.

In addition, there is a need to improve the light-room contrast ratio by reducing reflection of ambient light on the front substrate. In order to reduce it, a method of increasing a ratio of black portions by forming a black stripe on the front substrate has been suggested in order to absorb the ambient light. However, such a method reduces the aperture ratio which is not desired.

The above discussion in this section is to provide background information about the PDP devices. No statements in this section constitute an admission of prior art.

### SUMMARY OF CERTAIN INVENTIVE ASPECTS

Various aspects of the present invention provide a plasma display device with a structure that is capable of realizing high efficiency and enhanced display quality.

One aspect of the invention provides a plasma display device. The device comprises a front substrate comprising a display surface on which a visible image is displayed; a rear substrate; a plurality of discharge cells located between the front and rear substrates, the plurality of discharge cells comprising a discharge cell, which comprises a front surface generally facing the rear substrate; and a phosphor formed on the front surface.

The front surface may comprise at least one recess formed into the front substrate. Each recess may have at east one recess surface and the phosphor may be formed on at least part of the at least one recess surface. The at least one recess may comprise two or more recesses. Each recess surface may have a boundary on its front surface, and the boundary is substantially circular, elliptical or polygonal. At least one recess may have a generally shape selected from the group consisting of a cone, a truncated cone, a circular cylinder, a column, a hemispheroid, a hemisphere, a zone of a sphere, a tetrahedron, a cube, a parallelpiped, a polygon, a polygonal column, and a pyramid.

The front surface of the discharge cell may comprise a central recess formed into the front substrate about the center of the front surface and a peripheral recess formed into the front substrate about a periphery of the front surface. The central recess may be larger than the peripheral recess. Each of the central and peripheral recesses may have a boundary on the front surface, and the boundary of the central recess may be larger than the boundary of the peripheral recess.

At least one recess surface comprises a curved surface. Each recess may have a depth of the about 0.2% to about 10% of the thickness of the front substrate. The phosphor may be formed substantially throughout the at least one recess surface. The phosphor may have a thickness generally the same throughout the at least one recess surface.

The above described device may further comprise a plurality of barrier ribs between the front and rear substrates. The plurality of barrier ribs may partition the plurality of discharge cells, and each of the barrier ribs may comprise an end contacting the front surface of the discharge cell, and the recess may extend over the end of one of the plurality of barrier ribs.

The phosphor may have a thickness from about 4 μm to about 28 μm. The front surface of the discharge cell may comprise a surface of the front substrate opposing the display surface. The above described device may further comprise a layer formed on an interior surface of the front substrate opposing the display surface. The front surface of the discharge cell may comprise a surface of the layer facing away from the display surface.

The above described device may further comprise a plurality of barrier ribs and a plurality of electrodes between the front and rear substrates. The plurality of electrodes may comprise an electrode buried in the plurality of barrier ribs. The above described device may further comprise a first electrode, a second electrode and a barrier rib formed between the front and the rear substrates. The first and second electrodes may be buried in the barrier rib extending in a first direction and generally extend together with the barrier rib while apart from each other in a second direction perpendicular to the first direction.

The above described device may further comprise a third electrode extending in a third direction perpendicular to the first and second directions, and the third electrode is not buried in the barrier rib. The above described device may further comprise a first electrode and barrier ribs. The barrier ribs may provide sidewalls of the discharge cell, and the first electrode may be buried in the barrier ribs and substantially surrounds the discharge cell.

The above described device may further comprise a second electrode which is also buried in the barrier ribs and surrounds the discharge cell. The first electrode may comprise a first portion buried in one of the barrier ribs, and the second electrode may comprise a second portion buried in the barrier rib. The first and second portions may extend together with the first barrier rib in substantially the same direction while not contacting each other.

Another aspect of the invention provides a method for manufacturing the above described device. The method comprises providing an intermediate product comprising a surface to serve as a front surface of the discharge cell; forming a recess on the surface of the intermediate product; and forming the phosphor on at least part of the at least one recess surface. The recess has at least one recess surface. The intermediate product may comprise the front substrate, and forming the recess may comprise etching the surface of the front substrate.

Another aspect of the invention provides a method for displaying an image. The method comprises providing the above described device; and stimulating the device to create a plasma discharge within the discharge cell. The plasma discharge activates the phosphor formed on the front surface to emit light through the front substrate, and the emitted light contributes to display an image on the display surface.

### BRIEF DESCRIPTION OF THE DRAWINGS

The above and other features and advantages of the present invention will become more apparent by describing in detail exemplary embodiments thereof with reference to the accompanied drawings.

FIG. 1 is a partial exploded perspective view of a PDP according to one embodiment.

FIG. 2 is a partial cross-sectional view of a discharge cell taken along the line II-II of FIG. 1 when the PDP of FIG. 1 is assembled.

FIG. 3 is a partial perspective view of electrodes in accordance with an embodiment.

FIG. 4 is a partial cross-sectional view of the discharge cell taken along the line IV-IV of FIG. 2.

FIG. 5 is a partial cross-sectional view of a discharge cell according to an embodiment.

FIG. 6 shows exemplary input signals for driving the discharge cell of FIG. 5 in accordance with an embodiment.

FIG. 7 is a partial perspective view of electrodes in accordance with an embodiment.

FIGS. 8-13 are partial plan views schematically showing a discharge cell and recesses for phosphors according to various embodiments.

FIGS. 14 and 15 are perspective views showing various configurations of electrodes according to embodiments.

### DETAILED DESCRIPTION OF EMBODIMENTS

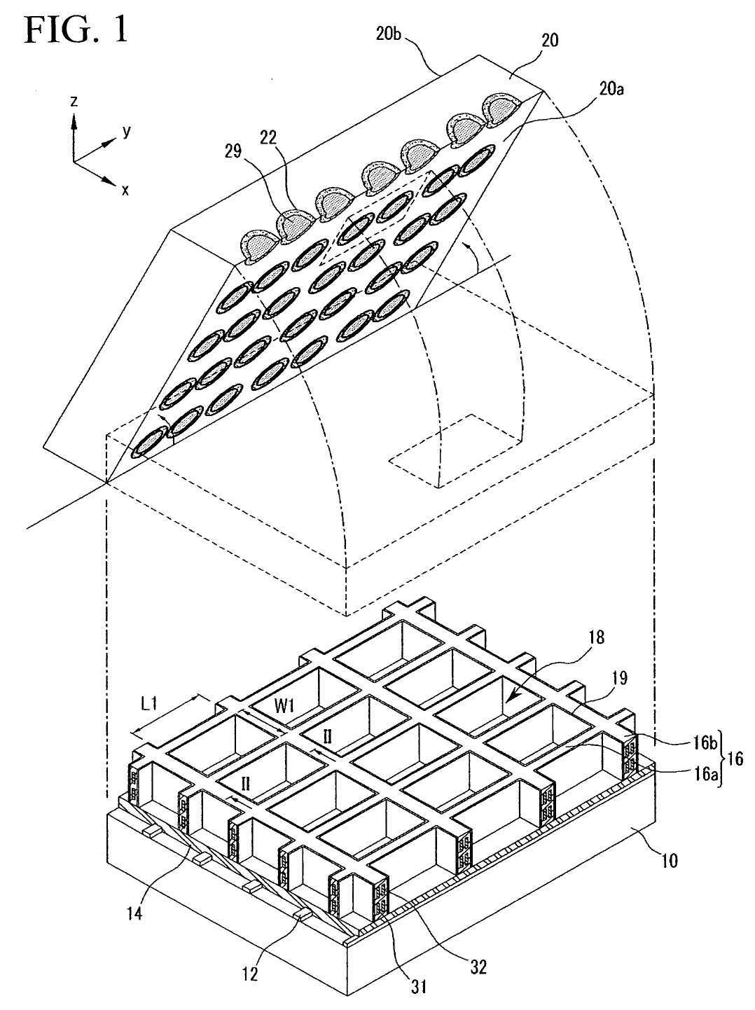

Hereinafter, embodiments of the present invention will be described with reference to FIGS. 1 to 15. These embodiments are merely to illustrate various features and aspects of the present invention, and the present invention is not limited to the illustrated embodiments. In embodiments, like elements are referred to with like reference numbers.

Referring to FIG. 1, the PDP according to an embodiment includes a rear substrate 10 and a front substrate 20. The rear substrate 10 is spaced apart from the front substrate 20 by a predetermined distance, and the space is partitioned into a plurality of discharge cells 18 by barrier ribs 16. A discharge gas is filled the discharge cells 18, and phosphors 29 are formed on the front substrate 20.

As illustrated in FIG. 1, electrodes 12, 31 and 32 are formed to pass by discharge cells 18. The electrodes include an address electrode 12, a scanning electrode 31, and a sustain electrode 32. The address electrode 12 extends along discharge cells 18 on a surface of the rear substrate 10. The scanning electrode 31 and sustain electrode 32 are buried in the barrier ribs 16 and pass by each discharge cell 18. A dielectric layer 14 is formed on the entire surface of the rear substrate 10 to cover the address electrodes 12.

Barrier ribs 16 are formed on the dielectric layer 14. In the illustrated embodiment, the barrier ribs 16 include first barrier rib members 16a and second barrier rib members 16b. The first barrier members 16a extend in a direction parallel to the address electrode 12 (y-axis). The second barrier rib members 16b extend in a direction crossing the address electrode 12. For example, the second barrier rib members 16b are substantially perpendicular to the address electrode 12 and extend in the x-axis. Although not illustrated, barrier ribs 16 may be formed in various configurations other than a grid or matrix as shown in FIG. 1.

In the illustrated embodiment, the discharge cell 18 is shaped in a substantially rectangle by the barrier ribs 16. L1 refers to the length of the discharge cells 18 measured in the y-axis. W1 refers to the width measured in the x-axis. Again, the discharge cells 18 may be formed in various configurations and are not limited to the illustrated configurations.

In addition, in the illustrated embodiment, scanning electrodes 31 and sustain electrodes 32 are spaced apart from each other by a predetermined distance in the z-axis. The scanning and sustain electrodes 31 and 32 are disposed in the barrier ribs 16 such that they do not block visible rays from passing through the front substrate 20. The scanning and sustain electrodes 31 and 32 may be formed of an electrically conductive material including a metal. The barrier ribs 16 electrically insulate the scanning electrode 31 and the sustain electrode 32 buried therein. The barrier ribs 16 are made of dielectric materials and prevent charged particles that are generated by the discharge from directly colliding into the scanning electrode 31 or sustain electrode 32. Furthermore, the barrier ribs 16 accumulate wall charges, which will be appreciated well by the skilled artisan in the appropriate art.

A protective layer 19 can be formed on side surfaces of the barrier ribs 16, in which the scanning electrode 31 and the sustain electrode 32 are buried. The protective layer 19 may be selectively formed on portions that are likely to be exposed or contacted by charged particles generated during plasma discharge in the discharge cells 18. The protective layer 19 protects the barrier ribs 16 that are made of dielectric materials and accordingly protects scanning electrode 31 and the sustain electrode 32 from collision by charged particles. In one embodiment, the protective layer 19 is made of a material having a high secondary electron emission coefficient, thereby releasing secondary electrons which improve the efficiency of discharge.

Since the protective layer 19 covers side surfaces of barrier ribs 16, it does not block the visible rays generated in the discharge cells 18 during a plasma discharge. Therefore, it may be made of opaque materials such as MgO. Since MgO does not transmit visible rays and has a much higher secondary electron emission coefficient than a material that transmits visible rays, it is possible to further improve discharge efficiency.

In the illustrated embodiment, recesses 22 are formed on a surface 20a of the front substrate 20 which faces the rear substrate 10. A plurality of green, red, and blue phosphors 29 are individually formed in each of the recesses 22.

In one embodiment, phosphors 29 are formed on the recesses 22. In embodiment, no additional phosphors are formed on the barrier ribs 16, the rear substrate 10 or the dielectric layer 14. Forming the phosphors 22 only on the front substrate 20 may significantly simplify manufacturing process, thereby reducing the processing costs. In other embodiments, however, phosphors may be formed on either of both the side walls (barrier ribs) of the discharge cells 18, the rear substrate 10 or dielectric layer 14. Although not illustrated, phosphors are formed on the surface 20a of the front substrate that does not have a recess or where no recess if found. According to one embodiment, the front substrate 20 may be etched to produce a plurality of recesses 22. The phosphors 29 can be formed on the surface of the recesses 22.

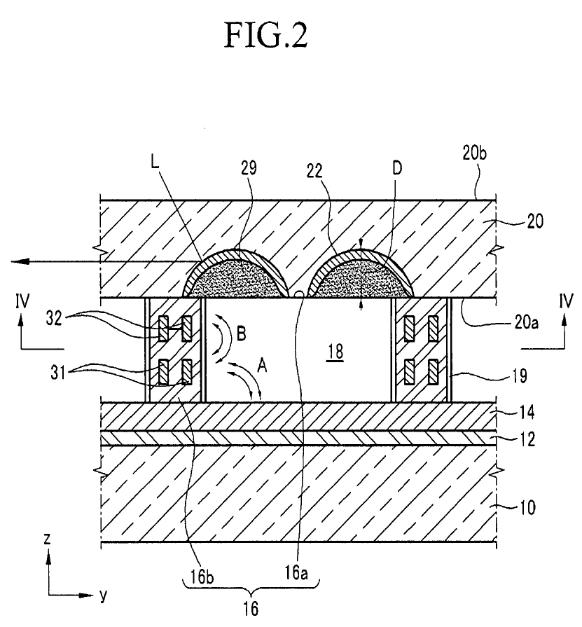

An exemplary operation of the PDP will be explained with reference to FIG. 2 below. Referring to FIG. 2, the discharge cell 18 is selected to be turned on by the address discharge A between the address electrode 12 and the scanning electrode 31. After the selection of the particular discharge cells 18, the sustain discharge B is generated between the scanning electrode 31 and the sustain electrode 32 of the discharge cell 18. The plasma discharges in the discharge cell 18 activate the phosphor 29 which emits certain visible light which passes through the front substrate 20. The emitted light contributes to display an image on the display surface 20b, and the image can be displayed on the display surface 20b. The operation of the PDP may differ depending on signal inputs to the electrodes. Therefore, the present invention is not limited to the aforementioned method.

In the embodiment of FIGS. 1 and 2, the scanning electrode 31 is disposed between the rear substrate 10 and the front substrate 20. This configuration minimizes the distance between the scanning electrode 31 and the address electrode 12, and therefore reduces an initial discharge voltage for the address discharge A. As shown in FIG. 2, the scanning electrode 31 is located close to the rear substrate 10 and the sustain electrode 32 is located close to the front substrate 20 for shorter distance for the address discharge A, although not limited thererto.

The sustain discharge generated between the scanning electrode 31 and the sustain electrode 32 is formed by electric fields having components extending in z-axis. The electric field, which is formed by a voltage applied between the scanning electrode 31 and the sustain electrode 32, are concentrated about the center of the discharge cell 18. Therefore, emitting efficiency can be improved and an ion sputtering phenomenon that may be generated by a discharge can be prevented or reduced even if the discharge is continued for an extended period of time.

In embodiments, the discharge cell 18 is surrounded by the scanning electrode 31 and the sustain electrode 32. As a result, the sustain discharge can be formed throughout along the side surfaces of the discharge cell 18.

In the illustrated embodiment, the recesses 22 are formed on the front surface 20a of the discharge cell 18, and the recessed surface generally faces away from the display surface 20b displaying an image. In embodiments, the recesses 22 can be formed by selectively etching a portion of the front substrate 20. Alternatively, the front substrate 20 may be molded to include the recesses 22.

As shown in FIG. 2, the discharge cell 18 includes two recesses 22 along the y-axis. Although not illustrated, the discharge cells 18 may have varying numbers of recesses arranged along the y-axis. 1, 2, 3, 4, 5, 6, 7, 8, 9, 10 etc. Also, the size of the recesses 22 in a single discharge cell 18 may be the same or different. As the number of the recesses 22 are increased, the surface area of the phosphors 29 is increased. The phosphor 29 is formed on a part or substantially all of the surface of the recess 22. The concaved or recessed deposit of the phosphors 29 provides an area to generate visible light that is larger than such an area but for the recesses 22. As the area of the phosphors 29 which can absorb vacuum ultraviolet rays and emits visible rays becomes large, an amount of visible ray can be increased, and thereby brightness can be improved. The recesses 22 also dispersed light (L) from the outside rather than reflecting back to the outside, thereby improving light-room contrast ratio.

In the illustrated embodiment, the recesses 22 are substantially a hemispheric although not limited thereto. For example, the recess can have a generally negative three-dimensional shape of at least one selected from the group consisting of a cone, a truncated cone, a circular cylinder, a column, a hemisphere, a zone of a sphere, a tetrahedron, a cube, a parallelpiped, a polygon, a polygonal column, and a pyramid. The boundary of each recess 22 with the surface 20a of the front substrate 20 has a generally two-dimensional shape be as a circle. The recessed surfaces of the discharge cell 18 can be a curved surface although they can be substantially flat with sharp or rounded corners. The boundary can also have a shape of generally an oval and a polygon. Again, the curved surface of the recess 22 helps the light (L) from the outside be effectively dispersed rather than reflected back.

Each recess 22 has a depth D measured from the surface 20a of the front substrate 20 toward the display surface 20b in the z-axis. The recesses 22 have a predetermined depth. The depth D of the recesses 22 is in a range from almost about 0.2% to about 10% of the thickness of the front substrate 20. The depth D of the recess 22 may be approximately 0.1%, 0.3%, 0.5%, 0.7%, 0.9%, 1%, 2%, 3%, 4%, 5%, 6%, 7%, 8%, 9%, 11%, 12%, 13%, 14%, 15%, 16%, 17%, 18%, 19% or 20% of the front substrate 20.

The phosphor 29 can have a predetermined thickness. The phosphors 29 need to have a sufficient thickness to provide sufficient brightness when discharge occurs. On the other hand, the phosphor 29 should not be too thick to block significant amount of visible light generated by it. In embodiments, the phosphor 29 has a thickness from about 4 μm to about 28 μm. The thickness of phosphors in the recess may be approximately 2, 4, 6, 8, 10, 12, 14, 16, 18, 20, 22, 24, 26, 28, 30, 32, 34, 36, 38 or 40 μm.

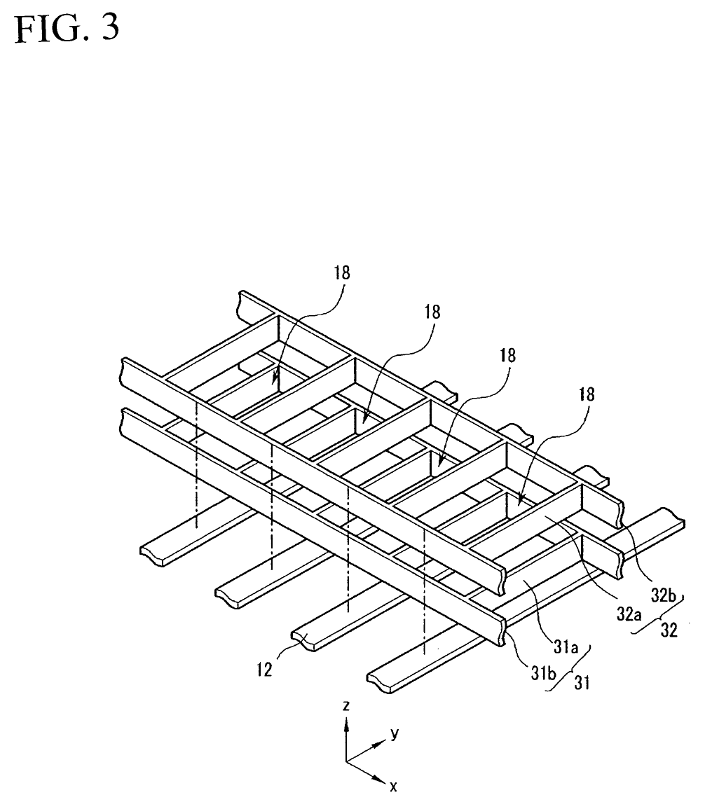

FIG. 3 shows a configuration of the scanning and sustain electrodes 31 and 32 that can be applied to the PDP shown in FIG. 1 or others. The scanning electrode 31 and the sustain electrode 32 include first portions 31a and 32a and second portions 31b and 32b, respectively. The first portions 31a and 32a are disposed in a direction parallel to the address electrodes 12 in the first barrier rib member 16a (FIG. 1). The second portions 31b and 32b are disposed in a direction crossing the address electrodes 12 in the second barrier rib member 16b. (FIG. 1) The scanning electrode 31 and the sustain electrode 32 may be shaped in configurations other than as shown in FIG. 3.

In the embodiment of FIG. 3, a pair of neighboring discharge cells 18 shares the first portion 31a and 32a. The scanning electrode 31 and the sustain electrode 32 extend in a direction to be crossed with an extending direction of the address electrodes 12 (x-axis direction in FIG. 3).

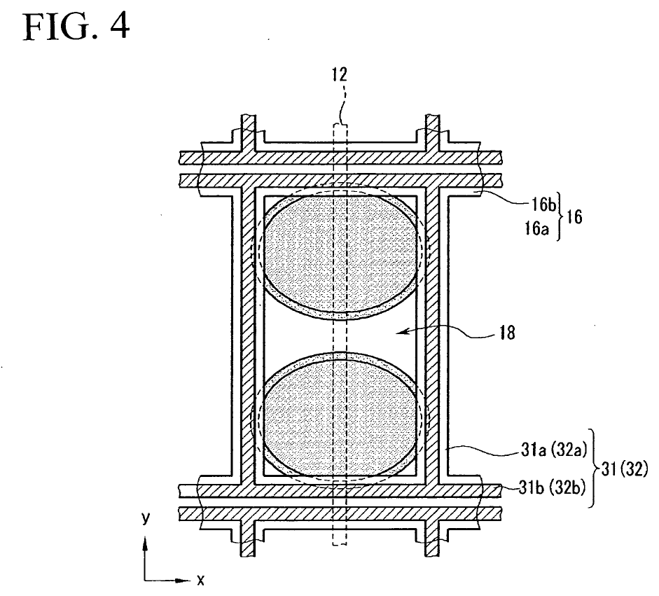

Referring to FIG. 4, two of the recesses are formed for one discharge cell 18. The two recesses are arranged along the y-axis and formed on the front substrate. In embodiments, there may be more recesses formed in a single discharge cell. Also, in embodiments, more than two recesses may be arranged along the y-axis or another direction. The recesses may be randomly positioned or the front surface 20a. The recesses can have a variety of arranging shapes and numbers thereof.

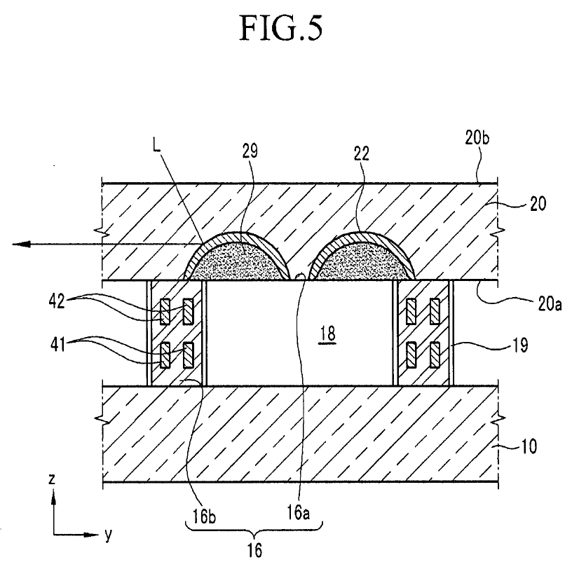

In the embodiment illustrated in FIG. 5, electrodes 41 and 42 for generating plasma discharge are installed in the discharge cell 18. The electrodes 41 are referred to as an “address electrode.” The electrodes 42 are referred to as a “scanning electrode.” The address electrode 41 and the scanning electrode 42 are spaced apart from each other by a predetermined distance in the barrier rib 16 in the z-axis. Both the address electrode 41 and the scanning electrode 42 are disposed in the barrier rib 16 and electrically insulated from each other by the material of the barrier rib 16. Unlike the embodiments illustrated FIGS. 1-4 which requires a set of three electrodes for operation of a single discharge cell, the embodiment of FIG. 5 forms a two-electrode configuration which require only two electrodes for operation. Other than this, this embodiment is identical to the previous embodiments and includes all the features and benefits thereof.

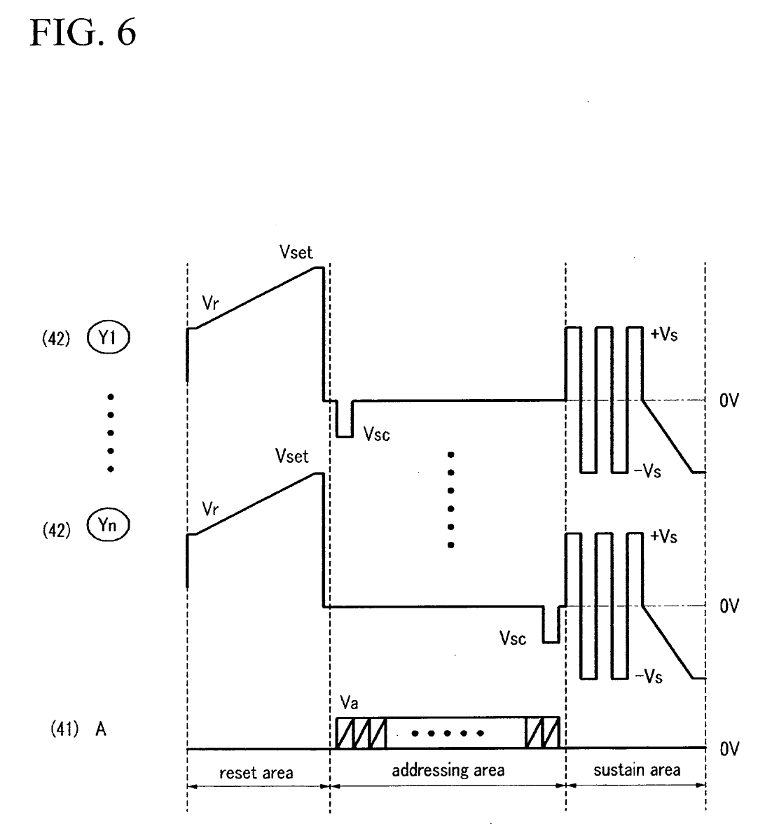

FIG. 6 illustrates signal inputs for the PDP having the two-electrode configuration. Driving waveforms of the address electrode 41 and the scanning electrode 42 related to the discharge of one discharge cell will be explained. The address electrode 41 is referred to as an Electrode A and the scanning electrode 42 is referred to as an Electrode Y for convenience.

One subfield of signals includes a reset area (period), an addressing area (period), and a sustain area (period). Here, while a reference voltage (0V in FIG. 6) is applied to the Electrode A (address electrode) in the reset area, a pulse that decreases to the reference voltage (0V) is applied after a voltage that is gradually increased from a positive sustain voltage Vr to a voltage Vset that can generate discharge in discharge cells in any condition is applied to the Electrode Y (scanning electrode). That is, a voltage of Electrode Y is increased in a shape of a ramp. Therefore, the discharge cell can be initiated with a weak discharge that is generated between Electrode Y and Electrode A while the voltage of Electrode Y is increased. In addition, the reset area does not have an area in which a voltage is gradually decreased after voltage Vset is applied to Electrode Y, and thereby a reset time can be reduced.

Next, a scan pulse Vsc is applied to Electrode Y in order to select a discharge cell in the addressing area and an address pulse Va is applied to Electrode A. A reference voltage 0V is then applied to Electrode A in the sustain area and a positive sustain pulse +Vs and a negative sustain pulse −Vs are repetitively applied to Electrode Y, thereby displaying an image. An erase pulse, which is gradually decreased from the reference voltage 0V to the negative sustain voltage −Vs, is applied to Electrode Y in an end portion of the sustain area while a reference voltage 0V is applied to Electrode A. Then, a weak discharge is generated between Electrode Y and Electrode A while a voltage of Electrode Y is reduced. Therefore, a wall charge that is formed by the sustain voltage is erased.

As described above, discharge is performed in the reset area, the addressing area, and the sustain area by using waveforms that are applied to Electrode Y while Electrode A is biased as a reference voltage 0V. Therefore, it is possible to remove the sustain electrode from a structure of three electrodes and a driving circuit for driving it, and therefore the cost of the circuit can be reduced. The aforementioned driving method is one of an example for the PDP according to the second embodiment of the present invention, and the present invention is not limited thereto. In addition, other driving methods can be applied to various embodiments of the present invention.

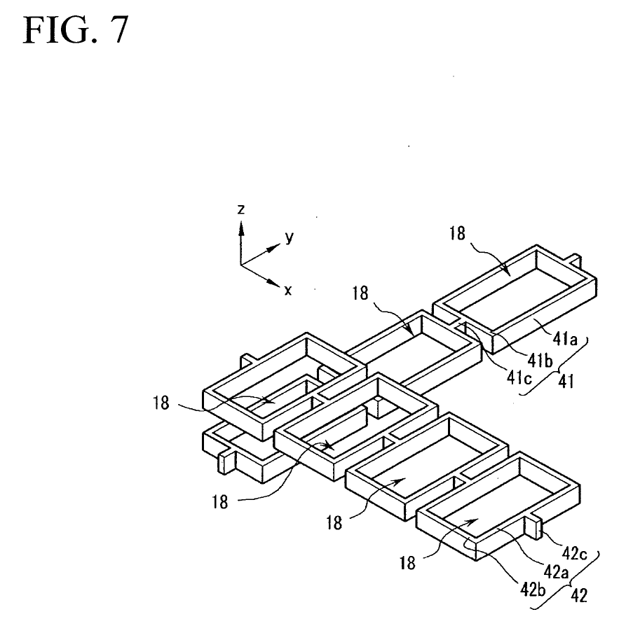

FIG. 7 shows an embodiment of electrodes that can be needed in FIG. 5. An address electrode 41 includes a first portion 41a, a second portion 41b, and a third portion 41c. The first portion 41a is formed in a first rib barrier member 16a along the y-axis. The second portion 41b is formed in a second rib barrier member 16b along the x-axis. The third portion 41c interconnects adjacent second portions 41b. The address electrode 41 extends generally straight in y-axis in FIG. 7.

Furthermore, the scanning electrode 42 includes a first portion 42a, a second portion 42b, and a third portion 42c. The first portion 42a is formed in a first rib barrier member 16a along the y-axis. The second portion 42b is formed in a second rib barrier member 16b along the x-axis. The third portion 42c interconnects adjacent first portions 42a. The scanning electrodes 41 extends generally straight along the x-axis.

As illustrated, the address electrode 41 and the scanning electrode 42 cross with each other, and a portion of each surrounds a single discharge cell 18. Therefore, they take part in an address discharge, by which a discharge cell 18 to be turned on and in a sustain discharge in which lighting emitted with a predetermined brightness. The address electrode 41 and the scanning electrode 42 surround the discharge cells 18, thereby effectively utilizing discharge space and space charges and improving discharge efficiency.

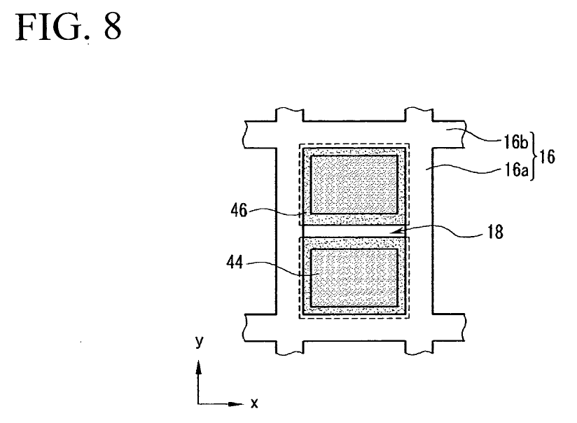

In embodiments of various discharge cells, recess and phosphor configurations are illustrated in FIGS. 8-13. Referring to FIG. 8, recesses 44 are formed in substantially rectangular discharge cell. A phosphor 46 is formed in the recess 44 and forms another rectangular shape. The recessed surface may be curved or may have a substantially flat portion. The recess 44 and the phosphor 46 have a planar shape, thereby maximizing a surface area of the phosphor 46 in each of the discharge cells 18 having a planar shape of a rectangle. In this embodiment, two recesses 44 are formed for the single discharge cell 18 while they are arranged along a longitudinal direction of each of the discharge cell (y-axis direction in FIG. 8).

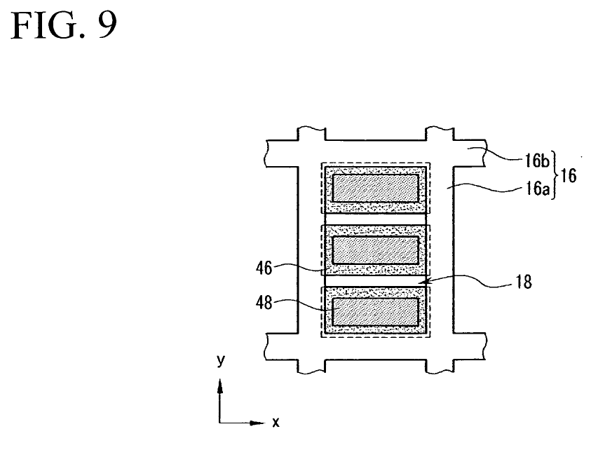

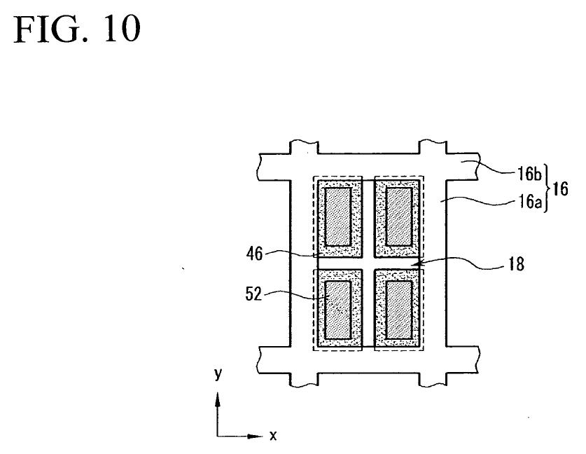

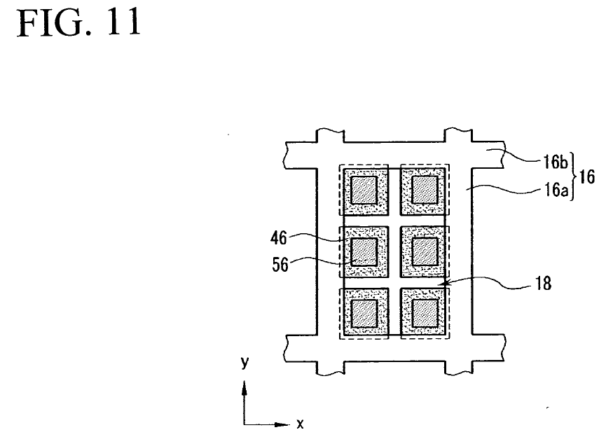

Referring to FIG. 9, three rectangular recesses 48 are formed for the discharge cell 18. Referring to FIG. 10, four substantially rectangular recesses 52 are formed in the discharge cell 18. The recesses 52 having a pair of rows are arranged along a longitudinal direction of the discharge cell 18 and two recesses 52 are formed in each row. Referring to FIG. 11, six rectangular recesses 56 are formed in the discharge cell 18.

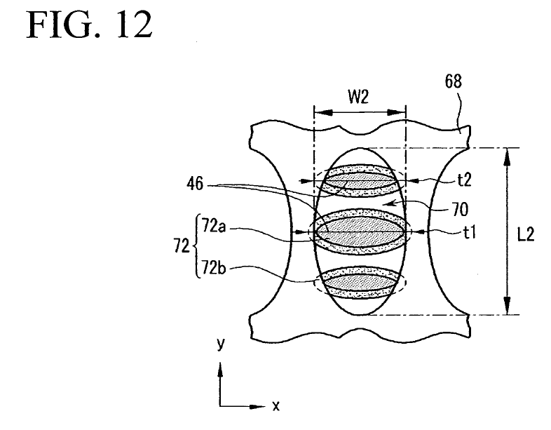

In the embodiment illustrated in FIG. 12, the discharge cell 70 partitioned by a barrier rib 68 is substantially an oval. Alternatively, the discharge cell 70 may be a circular shape. The recesses 72 are formed along the y-axis. In the illustrated embodiment, the t1 is a length of a recess 72a which is disposed in the center portion of the discharge cell 70 along the x-axis. The t2 is a length of a recess 72b which is disposed on a peripheral portion of the discharge cell 70 along the x-axis. In one embodiment, t1 is larger than t2.

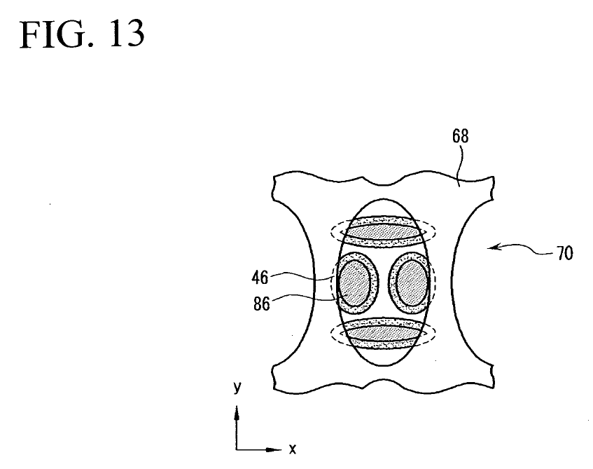

FIG. 13 illustrates another embodiment, in which differently shaped recesses 86 are formed in one discharge cell. In this embodiment, more recesses 86 are formed in the center portion of the discharge cell 70 than peripheral portions thereof.

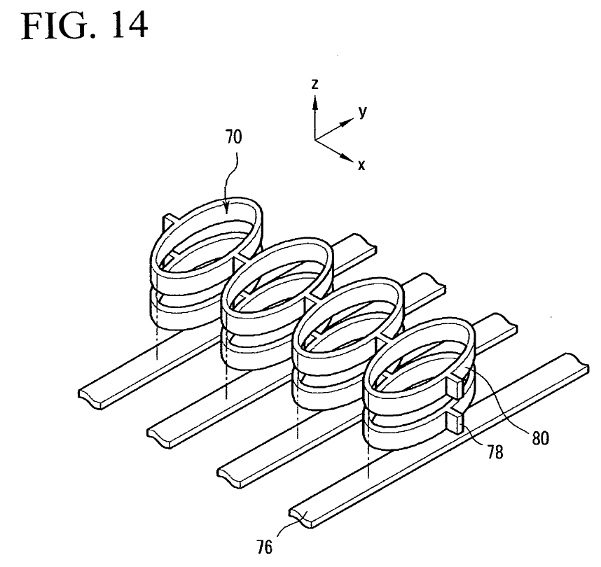

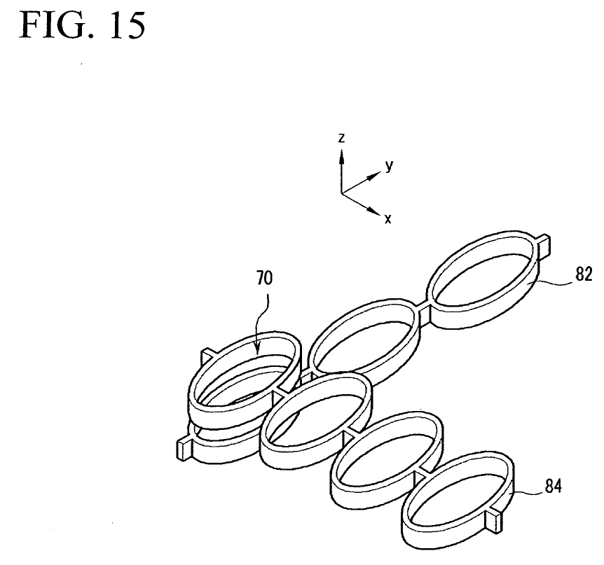

FIG. 14 illustrates a set of three electrodes including a first electrode 76, a second electrode 78, and a third electrode 80 as in embodiments shown in FIGS. 1-5. In this case, planar shapes of the second electrode 78 and the third electrode 80 buried in the barrier rib can be oval. These shapes correspond to that of the discharge cell 70. On the other hand, FIG. 15 illustrates a set of two electrodes including a first electrode 82 and a second electrode 84. In this case, planar shapes of the first electrode 82 and the second electrode 84 buried in the barrier rib can be oval. These shapes correspond to that of the discharge cell 70.

According to various embodiments of the present invention, recesses are formed in the front substrate and at least one recess is suitably arranged in each of the discharge cell. As a result, area of the phosphors which corresponds to each of the discharge cells can be maximized, and the amount of visible rays can be increased and the brightness of the PDP can be improved.

In addition, a recessed surface can disperse incoming light from the vent it from reflecting back. As a result, light-room contrast ratio can be out increasing a ratio of black portions. The electrodes can be formed to of the discharge cells so that a discharge space and space charges that are can be increased. Therefore, discharge efficiency of the PDP can be enhanced.

Although the exemplary embodiments of the present invention have been described, it can be obviously understood by those skilled in the art that the present invention may be modified in various forms without departing from the spirit and scope of the appended claims.

What is claimed is:

1. A plasma display device, comprising:
a front substrate comprising a display surface, on which a visible image is displayed;
a rear substrate;
a plurality of discharge cells located between the front and rear substrates, the plurality of discharge cells comprising a discharge cell, which comprises a front surface generally facing the rear substrate; and
a phosphor formed on the front surface.

2. The device of claim 1, wherein the front surface comprises at least one recess formed into the front substrate, wherein each recess has at east one recess surface, and wherein the phosphor is formed on at least part of the at least one recess surface.

3. The device of claim 2, wherein the at least one recess comprises two or more recesses.

4. The device of claim 2, wherein each recess surface has a boundary on its front surface, wherein the boundary is substantially circular, elliptical or polygonal.

5. The device of claim 2, wherein at least one recess has a generally shape selected from the group consisting of a cone, a truncated cone, a circular cylinder, a column, a hemispheroid, a hemisphere, a zone of a sphere, a tetrahedron, a cube, a parallelpiped, a polygon, a polygonal column, and a pyramid.

6. The device of claim 1, wherein the front surface of the discharge cell comprises a central recess formed into the front substrate about the center of the front surface and a peripheral recess formed into the front substrate about a periphery of the front surface, and wherein the central recess is larger than the peripheral recess.

7. The device of claim 6, wherein each of the central and peripheral recesses have a boundary on the front surface, and wherein the boundary of the central recess is larger than the boundary of the peripheral recess.

8. The device of claim 2, wherein the at least one recess surface comprises a curved surface.

9. The device of claim 8, wherein each recess has a depth of the about 0.2% to about 10% of the thickness of the front substrate.

10. The device of claim 2, wherein the phosphor is formed substantially throughout the at least one recess surface.

11. The device of claim 10, wherein the phosphor has a thickness generally the same substantially throughout the at least one recess surface.

12. The device of claim 2, further comprising a plurality of barrier ribs between the front and rear substrates, wherein the plurality of barrier ribs partition the discharge cells from other discharge cells, and wherein the front surface of the discharge cell is defined by the plurality of the barrier ribs, and wherein the at least one recess is not totally confined within the front surface.

13. The device of claim 1, wherein the phosphor has a thickness from about 4 μm to about 28 μm.

14. The device of claim 1, wherein the front surface of the discharge cell comprises a surface of the front substrate opposing the display surface.

15. The device of claim 1, further comprising a layer formed on a surface of the front substrate opposing the display surface, wherein the front surface of the discharge cell comprises a surface of the layer facing away from the display surface.

16. The device of claim 1, further comprising a plurality of barrier ribs and a plurality of electrodes between the front and rear substrates.

17. The device of claim 16, wherein the plurality of electrodes comprise an electrode buried in the plurality of barrier ribs.

18. The device of claim 1, further comprising a first electrode, a second electrode and a barrier rib formed between the front and rear substrates, wherein the first and second electrodes are buried in the barrier rib extending in a first direction and generally extend together with the barrier rib while apart from each other in a second direction perpendicular to the first direction.

19. The device of claim 18, further comprising a third electrode extending in a third direction perpendicular to the first and second directions wherein the third electrode is not buried in the barrier rib.

20. The device of claim 1, further comprising a first electrode and a plurality of barrier ribs, wherein the plurality of barrier ribs provides sidewalls of the discharge cell, wherein the first electrode is buried in the barrier ribs and substantially surrounds the discharge cell.

21. The device of claim 20, further comprising a second electrode, wherein the second electrode is also buried in the barrier ribs and surrounds the discharge cell.

22. The device of claim 20, wherein the first electrode comprises a first portion buried in one of the barrier ribs, wherein the second electrode comprises a second portion buried in the barrier rib, wherein the first and second portions extend together with the first barrier rib in substantially the same direction while not contacting each other.

23. A method for manufacturing the device of claim 1, the method comprising:
providing an intermediate product comprising a surface to serve as a front surface of the discharge cell;
forming a recess on the surface of the intermediate product, the recess having at least one recess surface; and
forming the phosphor on at least part of the at least one recess surface.

24. The method of claim 23, wherein the intermediate product comprises the front substrate, and wherein forming the recess comprises etching the surface of the front substrate.

25. A method for displaying an image, the method comprising:
providing the device of claim 1; and
stimulating the device to create a plasma discharge within the discharge cell, wherein the plasma discharge activates the phosphor formed on the front surface to emit light through the front substrate, and wherein the emitted light contributes to display an image on the display surface.
